(19) United States
(12) Patent Application Publication
(10) Pub. No.: US 2025/0348271 A1
(43) Pub. Date: Nov. 13, 2025

(54) MULTIMODAL HUMAN-COMPUTER INTERFACE SYSTEMS

(71) Applicant: Michael Matas, Healdsburg, CA (US)

(72) Inventor: Michael Matas, Healdsburg, CA (US)

(21) Appl. No.: 19/204,273

(22) Filed: May 9, 2025

Related U.S. Application Data
(60) Provisional application No. 63/645,388, filed on May 10, 2024.

(51) Int. Cl. G06F 3/16; G06F 3/0488

(52) U.S. Cl. CPC G06F 3/167; G06F 3/0488

(57) ABSTRACT

Systems and methods for providing a multimodal user interface that integrates multiple forms of input and output in coordination with a generative output engine. A prompt management service receives inputs from two or more modalities, such as voice and touch, at substantially the same time (e.g., within a timeout or time window of one another) and aggregates information in respect thereof into a input context. Based on the input context, the system generates a structured prompt to a generative output engine, which returns a response comprising multimodal output data, including graphical interface elements, text, and executable code. The response is parsed to produce synchronized outputs across modalities such as rendering a user interface element while simultaneously providing a voice-based explanation. In some implementations, demonstrative language in a voice input may be associated to a specific user interaction, such as touching a visual affordance, to resolve ambiguity.

### CROSS-REFERENCE TO RELATED APPLICATION

This application is a nonprovisional of, and claims the benefit under 35 U.S.C. § 119 of, U.S. Provisional Patent Application No. 63/645,388, filed on May 10, 2024, and entitled “Multimodal Human-Computer Interface Systems” the contents of which is incorporated by reference in its entirety.

### TECHNICAL FIELD

Embodiments described herein relate to personal ideation and productivity systems, and in particular, to systems and methods for generating multimodal output from multimodal input by leveraging output from large language model output.

### BACKGROUND

Computing systems and applications assist computer users with various organizational and creative tasks, such as sketching, brainstorming, note taking, mind mapping, scheduling, calendaring, task management, and the like.

In many cases, however, a computer user is functionally required to leverage a large number of discrete and independent applications and services—some of which may only be accessible on particular devices—to accommodate all organizational and creative needs. In addition, input modalities and user interfaces to these applications are often limited. For example, input can be provided only via typed text, user interface affordance engagement (either by touch or selection with a cursor), or via voice interaction with a conversational chatbot or assistant. As a result, significant productivity, ideation, and creativity loss occurs as the user switches between different applications, user input paradigms, interfaces, and contexts.

### BRIEF DESCRIPTION OF THE DRAWINGS

Reference will now be made to representative embodiments illustrated in the accompanying figures. It should be understood that the following descriptions are not intended to limit this disclosure to one included embodiment. To the contrary, the disclosure provided herein is intended to cover alternatives, modifications, and equivalents as may be included within the spirit and scope of the described embodiments, and as defined by the appended claims.

FIGS. 1A-1B each depict a system for leveraging large language model output for rendering user interfaces to define a multimodal interface system application, as described herein.

FIGS. 2A-2B each depict a simplified schematic diagram of a multimodal interface system application instantiated by a client device, as described herein.

FIGS. 3A-3H depict a sequence of graphical user interface modifications that can result from interaction with a multimodal interface system application, supported by textual output of one or more large language models, as described herein.

FIG. 4 is a flow chart depicting example operations of a method of defining a graphical user interface from textual output of a large language model.

FIG. 5 is a flow chart depicting example operations of a method of providing multimodal output.

The use of the same or similar reference numerals in different figures indicates similar, related, or identical items.

Certain accompanying figures include vectors, rays, traces and/or other visual representations of one or more example paths-which may include reflections, refractions, diffractions, and so on, through one or more mediums that may be taken by, or may be presented to represent, one or more propagating waves of mechanical energy (herein, “acoustic energy”) originating from one or more acoustic transducers or other mechanical energy sources shown or, in some cases, omitted from, the accompanying figures. It is understood that these simplified visual representations of acoustic energy are provided merely to facilitate an understanding of the various embodiments described herein and, accordingly, may not necessarily be presented or illustrated to scale or with angular precision or accuracy, and, as such, are not intended to indicate any preference or requirement for an illustrated embodiment to receive, emit, reflect, refract, focus, and/or diffract acoustic energy at any particular illustrated angle, orientation, polarization, color, or direction, to the exclusion of other embodiments described or referenced herein.

It should also be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Embodiments described herein relate to systems and methods for providing input to and parsing output from a generative output system based on one or more large language models (“LLM”). Specifically, embodiments described herein relate to systems and methods of aggregating multiple modes of user input (e.g., audio, video, force, keyboard, affordance selection, cursor movement, and so on) into a single unified context to prompt a generative output system. Thereafter, output of the generative output system can be parsed to provide multimodal output back to the user that may include audio output, rendering or generating a graphical user interface, physical movement of one or more actuators, and the like.

These embodiments dramatically simplify interacting with, providing input to, and receiving output form computing device. For example, certain inputs may be more natural for a user to provide via voice input, whereas other inputs are more efficient and/or natural to provide via keyboard input, whereas yet other inputs are more efficiently captured via gesture detection on an input surface or via a depth-sensing system, such as a laser projection system. Likewise, certain outputs may be more natural for a suer to consume via audio output, whereas other outputs may be more natural or efficient for a user to consume via graphical user interface, whereas others still may be more natural or efficient to convey via haptic output or actuation of one or more actuators.

As an example, a user interacting with a computing device to perform a photo editing task may leverage a cursor and keyboard to interact with a user interface of a photo editing application. For conventional applications, a user must be aware of the physical location of certain tools and functionality, whether by icon location or menu location. In these examples the only input modalities provided to the user are keyboard input and cursor input. Further still, in conventional systems, the majority of interaction through these modalities is simplex input-only the keyboard or mouse is used at a time (e.g., only certain actions require and/or allow simultaneous use of the mouse and keyboard, such as a selection while holding a modifier key).

If a user desires to copy a layer, the user selects an input modality and leverages that input modality to perform the desired function. For example, a keyboard shortcut sequence (if known to the user) can be used to perform a function. In other cases, a cursor can be positioned over a particular affordance or menu item to perform the same function.

For embodiments described herein, multimodal input can be received and processed as a single input context. For example, a user may direct the mouse cursor over a section of an image and say “copy this color.” In this example, neither the cursor input nor the voice input on their respective own provide any context for the photo editing application or, more generally, the electronic device upon which the application is instantiated, to perform any function. Movement of the cursor to a given location does not, itself, convey the intent to copy a color. Similarly, a voice input of “copy this color” does not, itself, convey any context or antecedent support for the demonstrative pronoun “this.”

In embodiments described herein, however, the context of simultaneously or near-in-time user inputs can be combined to create a single user input context upon which computing actions can be taken in one or more applications.

In some embodiments, multiple input modalities can be accepted and multiple output modalities can be provided. In some embodiments, a user can provide input by, without limitation: voice instruction; video instruction; video-based gesture detection; user interface manipulation; peripheral device manipulation (e.g., accessory devices, such as mice, keyboards, joysticks, styluses, petals, eye tracking devices, depth sensing systems, touchpads, touch screens, three-dimensional mice, movement of an actuator, posing of a robotic arm or assembly, and so on); accessory or secondary device use (e.g., wearable devices, personal portable electronic devices, and so on); and the like. Output can be provided to the user across two or more modalities, such as and without imitation: displays; audio output; projected output; output via accessory devices; output via primary devices; haptic output; movement (e.g., robotic arms, positioning of displays or input components); and so on.

As with combined context in respect of multiple input modalities, outputs provided to a user across multiple output modalities can be split such that complete context is divided among individual output modalities. For example, a voice output of “you are available on this day” can be provided simultaneously and/or near-in-time with rendering of a calendar view that visually emphasizes a single day. This distributed and/or multimodal output can, in many examples, be more natural for a user to understand. In many cases, distributing output context may also be more secure and/or private. For example, eavesdropping persons nearby the user may not have full context to understand what the voice output of “your are available on this day” means.

In another example, a user may be completing a transaction online on a laptop computer. When presented with a text input field to provide credit card information, the user may say “I'll use the VISA™” From the combined context of the open webpage, frontmost application, and the voice input, the laptop device may access a secure information vault to retrieve a previously-stored VISA™ credit card. To inform the user that the instruction was received, the laptop device can provide an voice output of “VISA ending in 1234 selected,” can populate the appropriate information and may simultaneously instruct a nearby portable electronic device, such as a cellular phone, to render a number pad into which the user can confirm the security code of the associated VISA™. These foregoing examples are not exhaustive of possible multimodal input/output systems, as described herein.

In other cases, a user can provide touch input and voice input simultaneously to convey a single combined context. For example, a user can say “delete this” and touch an application on a home screen of a portable electronic device. In another example, a user may swipe over several days on a calendar and say “I'll be in California still.” In this example, from combined context, the computing device to which the inputs were provided may determine that appointments on the selected calendar days should be canceled.

In other cases, an output modality can include modifying a graphical user interface to focus or defocus particular elements, windows, text, or other content. As an example, in some embodiments, user interfaces can be dynamically generated to only include those affordances likely to be needed by a user to advance or complete a particular task with which the user is engaged. In other cases, voice input/output can be selected to solicit user input that may take a longer period of time to receive if an affordance were rendered in a graphical user interface.

In addition, these embodiments aggregate relevant information from multiple sources to reduce and/or eliminate context switching and information gathering by a user while completing a computing task. Embodiments described herein can likewise be leveraged to assist users with content memorialization (e.g., capturing, formatting, storage), data entry and/or data capture tasks—across multiple applications and services—in addition to or in place of data aggregation or data retrieval tasks described above.

In still further examples, multimodal input can be parsed to determine whether a particular input should be associated with a particular combined context, or another combined context. For example, while a user provides a voice instruction to perform a task related to vacation planning, the user may spontaneously recall another separate task. For example, the user may provide the voice input of “find directions between POINT A and—we need milk today too—and POINT B.” In response, systems as described herein can perform two separate tasks simultaneously, each related to and/or triggered by different user input contexts. A first context relates to direction finding, whereas a second context relates to shopping lists. These and other embodiments are described in detail herein.

More broadly embodiments described herein address an emergent inefficiency with purpose-configured and purpose-specific software. In particular, conventional graphical user interfaces rendered in respect of conventional software applications (whether such applications are executing over a portable electronic device such as a phone or tablet computer or otherwise) are substantially fixed and purpose-configured to render information and present options, features, and functionality only associated with that specific application. In most cases, each of these specific features can only be triggered via a single input modality—some by keyboard input, some by mouse input, some by voice input, and so on.

More broadly, applications are typically designed and implemented with dozens if not hundreds of features, each with a respective selector buried in a menu tree and/or an affordance element rendered in the graphical user interface that can only be selected with one specific input modality (e.g., selection via cursor). For substantially regular tasks, a user may only engage a minimal fraction of the available features.

Phrased in another manner, until the user learns to navigate a particular graphical user interface of a particular application, access to functionality desired by the user may be difficult to locate among many other rarely or never used affordances associated with rarely or never used program features. Even after the user learns a particular user interface layout, (1) software updates may introduce unexpected changes and/or add new features and corresponding menu items and affordances, (2) the user may accidentally engage an affordance that is not intended. requiring undo or other backtracking, and/or (3) content may be rendered in an ever diminishing portion of available display space reserved after all feature-specific, input-modality-specific affordances are rendered. These problems and inefficiencies persist to different degrees in each application leveraged by the computer user.

As a simple example, an email application is configured with a graphical user interface suitable for reviewing message lists and email bodies and many be manipulated by a mouse, whereas a note taking application can be configured with a graphical user interface that supports (as an example) stylus input and/or free form handwritten text input. A task management application may be configured to render tasks in a list with radio buttons and a project management application may be configured to render Gantt charts and calendars. Graphic design applications have interfaces supporting free form input, and spreadsheet applications have interfaces supporting the efficient display of numerical information. Generally and broadly, substantially all personal software is configured for a particular purpose with accompanying user interface design following functionality to accommodating that purpose.

However, as a computer user's needs for information capture, organization, and content generation expand, the user's suite of preferred applications may likewise expand. Each subsequent application introduced is associated with yet another graphical user interface, another learning curve, and another paradigm for providing input and saving information, and exporting information to other software platforms or applications.

As noted above, there often exists an inversely proportional relationship between the number of tools used by a computer user and the efficiency with which that user can leverage the most useful features of each application. In sum, as a user's computer needs expand, the user may become less efficient at information gathering. As a trivial example, a user may operate a task management application, a project management application, a time capture application, and a calendar application. Although all of these applications relate in some respect to the user's time commitments, the user may not be able to readily determine availability for a proposed meeting; the user must check several platforms before new commitments can be made.

In another example, the user may have a note taking application, a book reading application, a lecture playback application, and a photos application all of which are associated with certain, but different, content associated with the user's educational coursework. It may not be immediately clear to the user whether particular information is captured in notes, within a textbook, was presented during a lecture, or was screenshot from a slide presentation and stored in the photos application. As with preceding examples, although all of these applications relate in some respect to the user's education, the user may not be able to readily determine where certain information resides.

In other cases, a single task may require information stored by and/or accessible to multiple different applications, requiring the user to gather such information and aggregate that information appropriately in order to complete the tasks. For example, a user planning a dinner party with conventional systems may be required to access contact information from a contacts application, may be required to review scheduling information from a calendar application, may be required to search for a suitable meal plan or recipe set, create reminder to grocery shop for necessary ingredients and the like.

All of these discrete tasks require effort by the user to switch between different purpose-configured applications, and to navigate feature-rich purpose-specific user interfaces, to obtain small bits of relevant information that, in aggregate, assist in organizing the dinner party. For example, the user may be required to locate a calendar application, open the calendar application, select a date or view to display several dates, review prior commitments for potential conflicts (which may require changing views so as to see details such as start and end times), leverage one or more availability features in respect of proposed guests, and so on only to determine whether it may be possible to schedule the event.

In another example, a user monitoring calories for a medical reason may leverage a first application to track a metabolism related health parameter (e.g., blood glucose), may leverage a second application to input/enter meal information, and may leverage a third application to track workout activity. The user in some cases, may attempt to recall a blood glucose effect after a workout that followed a particular breakfast. In this example, the user may be required to leverage the third application to determine when the particular breakfast was last logged, switching then to the workout tracking application to understand whether, on that date, a workout was completed. If a workout was not found, the user returns to the third application to determine another time the particular breakfast was logged until a match between breakfast and workout is found. Only thereafter can the user leverage the user interface of the first application to determine a blood glucose response, given both a particular breakfast and a particular workout.

In these foregoing and other examples, cumbersome and time-consuming requirements of navigating multiple user interfaces, using required input modalities associated therewith, to retrieve small data items often result in the user abandoning their intended task (e.g., planning a dinner party, investigating associations between diet, exercise, and glucose response), especially if the information required from each application is not easily or readily retrievable by the user through user interface navigation. In other words, if the user is not intimately familiar with each user interface of each application, it may take additional time to understand how to navigate the user interface to obtain the information the user requires.

The foregoing examples are not exhaustive; it may be appreciated that generally and broadly purpose-configured software suites can lead to diffusion of personal information which in turn can increase the difficulty for the user of recalling or accessing that information and/or entering information in a useful location.

Some conventional systems have been proposed and implemented to address the information diffusion problems described above. For example, many computing platforms include an indexing service and a global search service that can leverage an index generated and maintained by the indexing service to provide quick search results to a user. However, in many cases, utility of a global search function may be limited by a user's ability to construct an accurate query via text input to a search field.

Search queries may return results from multiple software applications, requiring the user to launch those applications and navigate purpose-configured user interfaces to retrieve the desired information. Other conventional systems propose leveraging general purpose artificial intelligence to assist with querying indexes to retrieve relevant information. For example, one or more neural networks may be trained to return results responsive to a predicted user intent.

However, these systems are all fundamentally based on finding information and extracting that information from myriad sources; none of these conventional solutions assist computer users with data entry or content creation within the applications that were searched by the service.

Some conventional applications and platforms leverage generative pretrained transformers based on LLMs to automatically generate content to assist users with various tasks. For example, a generative output engine can be configured to summarize a text document, to consume a corpus of documents and generate summaries or query responses in response to text prompts provided as input by a user.

Generative output engines, however, by their nature and design, are configured for conversational interaction. More specifically, generative output engines leverage as input a timeseries of text inputs provided by a user conventionally referred to as a “prompt.” A user provides an initial prompt including an instruction and/or context in which to respond to a question, and in response a generative output engine provides a continuation of the input prompt that can be read as text by the user. In response to the generative output, the user can prompt the engine again to trigger another, updated response. Typically, this “conversational” flow is rendered in user interfaces in much the same manner as a chat application, requiring a user to scroll to review prior inputs and prior outputs.

Such conventional systems are useful to extract insights from information and/or to perform one or more tasks, but all such interactions are functionally required to follow a conversational form and format. This design constraint has resulted in chatbots and messaging agents being the primary applications of generative output technology. These implementations, being fundamentally text based, are of limited utility for many computer users.

In view of the foregoing, it may be appreciated that there may be a present need for improving the efficiency with which a user can interact with one or more devices, such as a tablet device, laptop device, desktop computer, or mobile phone.

Embodiments described herein relate to systems and methods for leveraging generative output engines, and specifically those based on LLMs, to consume information from one or more sensors and/or input devices to aggregate combined context under which to perform a particular task. In response, these systems can be configured to provide—as noted above—divisible output context that can choreograph outputs via one or more output system. For example, some output can be provided via a display and graphical user interface whereas other output can be provided in the form of audio output, whereas other output can be provided as text to speech output, whereas other output can be provided as haptic output, whereas other output can be provided via a secondary electronic device, whereas other output can be provided as physical movement of the electronic device (e.g., a robotic mechanism can re-pose or reposition itself).

Generally and broadly, a generative output engine as described herein or more generally any trained neural network configured to perform or coordinate operations as described herein, can be configured/prompted to parse multimodal user input events into one or more input contexts and, additionally, can be configured/prompted to provide parse-able output that in turn can be consumed by one or more output systems to provide physical, visual, or audio output.

For simplicity of description, many embodiments described herein reference a portable electronic device configured to provide multimodal output in the form of a graphical user interface and a voice output, but it may be appreciated that this is merely one example and that other systems can be configured in other ways; more or different output modalities are supported in further embodiments. Likewise, more or different input modalities are supported in further embodiments.

In an embodiment, a device as describe herein can be configured to dynamically generate user interface elements to define simplified, concise, user interfaces for receiving information from and providing information to a computer user. As a result of the systems and methods described herein, a computer user (more simply, a “user”) can interact with these dynamically-generated graphical user interface affordances in place of (i) engaging with feature-dense user interfaces of multiple applications, and (ii) in place of providing text input to a generative output engine.

As used herein, a system incorporating a generative output engine can be referred to as a “generative output system” or a “generative output platform.” Broadly, the term “generative output engine” may be used to refer to any combination of computing resources and/or trained machine learning systems (e.g., neural networks, pretrained transformers, vector support machines, vectorizers, and so on) that cooperate to instantiate or operated as an instance of software (an “engine”) in turn configured to receive a string prompt as input and configured to provide, as deterministic or pseudo-deterministic output, generated text which may include words, phrases, paragraphs and so on in at least one of (1) one or more human languages, (2) code complying with a particular language syntax, (3) pseudocode conveying in human-readable syntax an algorithmic process, or (4) structured data conforming to a known data storage protocol or format, or combinations thereof. The string prompt (or “input prompt” or simply “prompt”) received as input by a generative output engine can be any suitably formatted string of characters, in any natural language or text encoding.

In some examples, prompts can include non-linguistic content, such as media content (e.g., image attachments, audiovisual attachments, files, links to other content, and so on) or source or pseudocode. In some cases, a prompt can include structured data such as tables, markdown, JSON formatted data, XML formatted data, and the like. A single prompt can include natural language portions, structured data portions, formatted portions, portions with embedded media (e.g., encoded as base64 strings, compressed files, byte streams, or the like) pseudocode portions, or any other suitable combination thereof.

The string prompt received by a generative output system may include letters, numbers, whitespace, punctuation, and in some cases formatting. Similarly, the generative output of a generative output engine as described herein can be formatted/encoded according to any suitable encoding (e.g., ISO, Unicode, ASCII as examples).

In particular, some embodiments described herein receive input from a user of a computing device (herein, a “client device”) at a prompt management service. The prompt management service can, from the user's input (regardless of the schema used by the user to provide the input; input may be text, touch input, force input, voice, video and the like) from which a prompt may be generated and/or constructed.

The prompt generated by the prompt management service, in turn, may be provided as input to a generative output engine. The generative output engine provides a response to the prompt that is received back at the prompt management service. The prompt management service may be configured to parse the prompt to inform generation of a graphical user interface or graphical user interface element. The prompt management service can be additionally configured to retain context of prior prompts provided to the generative output engine so that already-generated user interface elements can be dynamically updated, in lieu of being replaced or re-rendered in response to future prompting by a user.

In addition, the prompt management service can be configured to extract from a generative output prompt descriptive information that can be used to provide a non-graphical output to the same user contemporaneously with rendering of a graphical user interface. For example, a graphical user interface element can be rendered while a text-to-speech module provides an auditory explanation of the user interface element. In some cases, the explanation may simply read text content of the graphical user interface element whereas in others, the spoken response may be phrased different and/or more concisely (or with more detail) in respect of the graphical user interface.

For example, a graphical user interface element or affordance generated by operation of a system as described herein can be a button, with text reading “Confirm” while contemporaneous nongraphical output may include a spoken phrase of “Should I schedule this meeting with Jane?” In this manner, two different outputs are provided simultaneously to the user that each refer to the same potential action (confirmation of an automatically-performed task, in this example), increasing context available.

In some cases, the non-graphical output can include an instruction to hardware of the client device, such as a haptic module or a movement actuator. For example, in addition to rendering a confirmation button (with or without animations), and in addition to providing a speech output, the client device can also provide a haptic feedback. As with dynamically-updated graphical user interfaces as described herein, the descriptive information (that may be used to generate speech) can be stored in a context-retaining manner.

In this manner, the prompt management service serves as an intermediary between the client device and a generative output engine.

More particularly, the prompt management service can be configured to wrap a user input received—regardless of modality (e.g., voice, text, touch input, and so on)—at the client device within one or more template prompts stored in a database. The template prompts can be engineered to instruct particular output forms and formats from the generative output engines to which the prompts may be provided as input. For example, a template prompt may request a generative output engine to provide a response in a structured data format such as JSON or XML that may be readable by the prompt management service.

In other cases, the prompt management service can be configured to generate a series of prompts from a single input context (which as noted herein can be assembled from multiple different simultaneous or near-in-time inputs provided to one or more input systems or sensor). In other words, the prompt management service may be configured to select from a prompt template database one or more prompt sequences or prompt plans that reference or otherwise identify a number of prompts that, when executed in a particular sequence, produce a desirable result that can be leveraged to generate a user interface as described herein.

For example, a first prompt may request an assessment or description of user intent (based on user demographics, device metadata and/or other context), a second prompt may request an identification of a third-party application from which to request information, a third prompt may be a request to dynamically generate a code snippet that executes an application programming interface (API) call to the third-party application to request particular information, and a fourth prompt may provide a textual response to the identified intent behind the user input (received from the first prompt) in addition to data retrieved from the third-party application. A fifth prompt may be configured to predict possible user actions upon presentation of information from the fourth prompt. A sixth prompt may be engineered to generate a user interface element (e.g., HTML element) functionally associated with one or more predicted actions that can be taken by the user such that if the user engages the user interface element, the associated function can be performed.

For example, a user may provide voice input to a computing device as described herein requesting “can I schedule an appointment at 1 pm on Monday?” At the same time, the user may be touching a touch screen over a rendered image advertising a matinee performance of a show. In response to receiving this multimodal input, computing device may generate a structured data object indicating all received inputs within a particular time window, which can include both the touch input and the voice input. The prompt management service can retrieve from a prompt template database a template engineered prompt that requests from a generative output engine an assessment of the user's intent in view of the combined context.

The prompt template can be automatically populated with context information obtained from the computing device itself and/or contextual information about the user, such as known user demographics, inferred user data (such as Know Your Customer (KYC) data), or user-provided demographic, occupation, or preference information.

For example, the prompt template may be populated with a list of installed applications (or application identifiers, application types, and so on), an operating system of the computing device, a device type for the computing device (e.g., laptop, desktop, tablet, phone, and so on), device parental controls status, the user's name, the user's age, the user's occupation description, the user's family relationships, the user's contact list, the user's address, and so on.

As noted above, the prompt template may be configured to request an assessment of the user's intent based on provided context. For example, a child may have a different suite of applications installed and may have different demographics than a working professional. From the context of applications or application types, the generative output engine may determine a different expected intent from the same textual input.

For example, a child requesting availability at 1 pm on Monday may be intending to understand a schedule of a parent or chaperone. A college student requesting availability at 1 pm may be intending to understand whether a class is scheduled at that time or whether a professor's office hours are available. A working professional requesting availability at 1 pm may be intending to understand whether an appointment already exists so that another appointment may be scheduled.

For example, the prompt management service can be configured to select and populate a template prompt that is structured as a JSON object such as follows:

```
{
  model: “model5”,
  messages: [{ role: “user”, content: “You are an intelligent assistant helping a user. First,
    you will determine what the user is intending to ask with the input ‘Can I
    schedule an appointment for 1pm on Monday’. The following context is
    provided to assist you: The user's age is {{user.age}}, the user's gender
    is {{user.gender}}, the user's current employment is
    {{user.employment_status}}. The user has made this request from
    {{device.application}} instantiated on a {{device.type}}. The user has
    these applications installed: {{device.installed_applications}}. Provide
    your output in the form only of a JSON string with a single key-value
    pair with the key being ‘response’ and the value being a string not to
    exceed 256 words. Provide no other output.” }],
  stream: true,
}
```

The prompt template includes a number of tokens that can be populated with user and device data, which may be populated automatically by operation of the prompt management service. It may be appreciated that the preceding example is simplified, and may be differently structured in different embodiments.

In response, the prompt management service may receive, from the generative output engine a response such as:

```
{
  response: “The user may be a college-age student, and is likely requesting information
    about a class schedule or the availability of a professor for office hours
    on the next calendar Monday at 1pm local time.”
}
```

In some cases, the prompt management service may modify the response to the first prompt in one or more ways prior to advancing to a next prompt of the set of prompts. For example, the prompt management service may be configured to replace conditional or passive voice language with definitive or active voice language. In this example, the prompt management service may execute a string replace operation to substitute “may be” for “is” and may substitute “likely” for an empty string to convert the above-received response to:

```
{
  response: “The user is a college-age student, and is requesting information about a class
    schedule or the availability of a professor for office hours on the next
    calendar Monday at 1pm local time.”
}
```

In other constructions, the prompt management service can be configured to modify the output of the generative engine in other ways; the foregoing example is nonlimiting.

Once an optionally modified prompt is received to indicate the user intent—or more specifically, a structured data response from the generative output engine in response to the populated template response is received—the prompt management service can retrieve from the prompt template database a template engineered prompt that requests from the generative output engine (which may be the same as the prior prompted generative output engine, or may be a different engine) a selection from a set of applications installed on the client device which applications potentially store relevant information to the intent determined by the response to the first prompt.

For example, scheduling questions may be answered with information extracted from a calendaring application, a task management application, and/or an email or messaging application (correspondence that may describe appointments or agreed-upon meetings not yet recorded as an appointment in the calendaring application).

In another example, student schedules may be determined from a class schedule PDF stored in a file store application, or alternatively available through a classroom portal application or web service. In another example, questions in respect of contacts or family members may be answered with information from device tracking applications, chat applications, multiplayer game applications, messaging applications, content sharing applications, and the like. Broadly, different applications may store information relevant to a user input or a portion of a user input.

As with other prompt templates described herein, the selected second template prompt may be populated with device-specific context including a set of installed applications and/or authenticated accounts to access remote services (e.g., email services, messaging services, and the like) in addition to the output response.

For example, the prompt management service can be configured to select a template prompt that is structured as a JSON object such as follows:

```
{
  model: “model5”,
  messages: [{ role: “user”, content: “You are an intelligent assistant helping a user. The
    user is a college-age student, and is requesting information about a class
    schedule or the availability of a professor for office hours on the next
    calendar Monday at 1pm. Your task is to identify which of these
    applications {{device.installed_applications}} and which of these
    accounts {{device.registered_accounts}} that may contain relevant
    information. The user has these applications installed:
    {{device.installed_applications}}. Provide your output in the form only
    of a JSON string with a single key-value pair with the key being
    ‘response’ and the value being an array not to exceed 10 elements. Each
    array value should correspond to an application or registered account
    available on the device. Provide no other output.” }],
  stream: true,
}
```

As with prior prompts, the second prompt template includes a number of tokens that can be populated with user and/or device data, which may be populated automatically by operation of the prompt management service.

In response, the prompt management service may receive, from the generative output engine a JSON object including an array of possible applications that may store or otherwise have access to information relevant to the original user input:

```
{
  response: [“Mail.app”, “Outlook.app”,“Calendar.app”,
    “Messages.app”,“MessagingAccount@service.com]
}
```

Thereafter, the prompt management service can be configured to select a third prompt template from the database that, like other templates described herein, can be populated with information relevant to prior prompts and responses.

In this example, the prompt management service may request the generative output engine to construct a code snippet that includes at least one API call to each of the applications identified as relevant to the user's initial input, thereafter receiving, as output, an executable code snippet that can perform the requested function in respect of a particular target application. For example, the prompt management service may be configured to select and/or populate a prompt template such as:

```
{
  model: “model5”,
  messages: [{ role: “user”, content: “You are a software developer assistant helping a
    user. The user is a college-age student, and is requesting information
    about a class schedule or the availability of a professor for office hours
    on the next calendar Monday at 1pm. Write a function in Python based
    on API definitions for Mail.app to retrieve relevant information. The
    function should provide as output a dictionary with two key value pairs.
    The first key-value pair has a key of ‘response’ and should have a value
    corresponding to a text explanation of an answer to the user's input
    based on retrieved information from Mail.app, the second key ‘data’
    should be a summary of the content on which the response is based.
    Provide no other output.” }],
  stream: true,
}
```

In some cases, developer documentation for a particular application can be provided as context along with the prompt to assist the generative output engine in generating the requested code snippet.

In response, the prompt management service may receive executable Python code, that when executed, leverages an API of Mail.app to retrieve information relevant to the user's initial prompt. Similar prompts may be constructed and/or populated in respect of the other identified applications (more broadly, data stores) and services, such as web services (e.g., email services, collaboration platforms, documentation services, and the like).

Thereafter, the prompt management service can provide as input each received snippet of code to a static analysis system and/or compiler to determine whether the code includes a security vulnerability and/or compiles. This operation is optional in many embodiments. In some cases, if a compilation error is detected, the prompt management service can provide the executable code snippet and the compilation error as yet another prompt to the generative output service to attempt to correct errors in the snippet. If compilation fails a threshold number of times, the code snippet may be discarded.

Once it is determined by operation of the prompt management service or another service that a received function is executable, the prompt management service can create a work item to add to a work item queue. A job scheduler and/or queue manager can pop items from the queue to instantiate an ephemeral virtual machine, container, or other computing environment in which to execute a particular snippet. Upon successful execution, results thereof can be passed back to the prompt management service for further processing.

After receiving one or more executions of purpose-configured code snippets generated by a generative output engine in response to populated templates as described above, the prompt management service may submit a final request to the generative output engine that includes all retrieved context from each application. This prompt may provide the generative output question with the initial user input question, the assumed intent of the user, contextual information about the device and the user, information retrieved from one or more applications installed on the user's device, and one or more services to which the user's device is authenticated (e.g., email services, messaging services, and the like).

Next, the prompt management service can select another prompt to request of the generative output engine what options the user may have in view of the answer provided. For example, continuing the example above, the prompt management service (after obtaining information from mail applications, class schedule applications, and calendar applications via custom code snippets each including purpose-configured API calls generated dynamically by a generative output engine) may determine that a suitable answer to the user's question is “Economics 320 is rescheduled for 1 pm on Monday, per Professor Smith's email last Thursday.”

From this conclusion, the prompt management service can populate another prompt to the generative output engine to request one of several options for next action by the user. For example, the selected template may be:

```
{
  model: “model5”,
  messages: [{ role: “user”, content: “You are an intelligent assistant helping a user. The
    user is a college-age student, and is requesting information about a class
    schedule or the availability of a professor for office hours on the next
    calendar Monday. The user is not available at 1pm on Monday due to a
    rescheduled class, as per {{device.calendar_app.event[123]}} and
    {{device.mail_app.message[1234]}}. Provide up to three suggestions
    for an action that can be taken by the user. Provide the response as a
    JSON-formatted array of strings. Provide no other output..”}],
  stream: true,
}
```

In response to such a prompt the generative output engine may suggest that (1) the user can email Professor Smith of the rescheduled class to request permission to miss class, (2) request more information about the yet-to-be-scheduled appointment at 1 pm on Monday, or (3) block time on Monday evening to review Monday's 1 pm class virtually.

From these responses, the prompt management service can request—by selecting yet another template prompt—the generative output engine to generate one or more HTML elements or native user interface elements corresponding to each possible action that can be taken by the user, each of which is identified by a unique identifier assigned by the prompt management service. In addition, the prompt management service can request a code snippet for each respective option generated.

Each unique identifier associated with each affordance or user interface element can be leveraged to provide multimodal output as described herein. More broadly, a first output modality can be synchronized in time with a second output modality by associating activation of one uniquely-identified object with activation of another uniquely-identified object. For example, as a device is providing voice output, a particular timestamp or word or phase can trigger an animation of a uniquely-identified user interface element. In this manner, voice output is synchronized with visual emphasis of a related user interface element in a dynamic nature.

As a result of creating ad hoc associations between different output modalities at runtime and/or output-time, devices as described herein can provide rich output to a user that is relevant to the user's current use of that device.

As with prior examples, each code snippet can be assigned to a job that can be executed by a worker node or virtual machine. In this manner, when the user selects an HTML element rendered in respect of the first suggested option, a respective first code snippet that performs the associated function can be executed (e.g., drafting an email with suitable content directed to Professor Smith).

Further to the foregoing, the prompt may also include an instruction to textually answer the user's initial prompt, and to present that textual response separately from the rendered HTML elements and affordances. The requested HTML page (or set of native user interface elements) can include one or more references to remote resources, such as remotely hosted style sheets or JavaScript resources.

The instructions to generate one or more user interface elements can be accompanied by additional context provided by the prompt management service, such as device information including device features, attributes, or components. For example, a different HTML element set may be generated for a tablet device with a touch or stylus input capability than for a laptop computing device with a keyboard and trackpad input capability.

Once an output is received form the generative output engine, the prompt management service can be configured to wrap one or more HTML elements within enclosing tags or elements in order to render suitable within a user interface of the client device. In many embodiments, the client device can thereafter be configured to render the user interface as received and/or instructed by the prompt management service. It may be appreciated that HTML rendering of custom user interface elements is merely one example by which user interface elements can be rendered; in some cases a native application user interface element may be rendered. For simplicity of description and illustration, the embodiments that follow reference embodiments that leverage HTML rendering engines to render custom user interfaces, but it is appreciated that this is merely one example construction.

In view of the foregoing, it may be appreciated that a prompt management service can consume input from multiple input sensors and/or multiple electronic devices to generate a combined context for one or more tasks requested by a user. Once this context is aggreged (e.g., sensor outputs and/or output parameters are combined into a single context object), the prompt management service can operate to select and populate sequential prompt templates to aggregate relevant context from multiple discrete applications, without requiring development effort to build integrations to obtain every possible data or content type from those applications, in order to generate a complete response to a user input prompt, while also providing a limited scope of possible next actions that can be taken by the user in response to the prompt, thereby significantly reducing cognitive overhead associated with determining which application to open next or which user interface element to next select. These options for next action can be rendered automatically for the user on a display of the user's client device. In many cases, the options can be rendered as a stream, whereas in other examples, the options can be rendered and/or highlighted or emphasized in coordination with other outputs, such as haptic outputs or voice outputs that provide additional context for a user in respect of functionality associated with the rendered options.

For example, a custom user interface may include three options. While each option is rendered, the computing device can be configured to provide a contextualizing voice output that suggests “select this option for TASK A” while rendering a visual emphasis of a first option of the three options. From the combined context of rendering visual emphasis and voice output, the user can understand the function of the first option.

In this manner, from the user's perspective, a question is asked and an answer is provided that pulls context from multiple applications storing data unique to the user and installed on the user's device and/or multiple services to which the user's device is permitted to couple. The user is not required to locate this information, nor is the user required to consider which user interface elements are required to access, copy, and/or otherwise obtain that information. Further still, as API calls are dynamically generated by the generative output system as needed, significant development effort is not required to support integration with an arbitrary number of applications or services that the user may leverage to store information.

In further embodiments, a user may be able to provide the initial user input in a number of ways. For example, in some embodiments, the client device can include a text-to-speech service that records a user's voice commands and instructions instead of receiving text input. In these examples, the user can ask a question about the user's own information, diffusely scattered across multiple applications and services, and in response, a rich graphical user interface can be rendered to enable the user to act on the answer to the user's initial input.

The user can interact with the device in a number of ways-such as via the graphical user interface (e.g., touch input, stylus input, keyboard/mouse input) or via a follow-up voice command. In either case, upon receiving a user input corresponding to a selection of a rendered graphical user interface element, a corresponding code snippet can be executed and a result thereof may be handled in a suitable manner.

For example, the user may select an option to message the user's professor by touching a touch screen of the client device. In this example, the unique identifier identifying the user interface element can be transmitted from the client device in a manner that causes a corresponding code snippet to execute, thereby causing (for example) the prompt management service to request the generative output engine for a draft email body, which can be provided and may be rendered for the user via the graphical user interface of the client device.

In other examples, the user may have follow-up questions, or may desire to modify the initial prompt. Unlike conventional systems architected for conversational flow that require vertical graphical user interface space to render conversational history, the prompt management service can, as noted above, tag each rendered user interface element with a unique identifier such that subsequent prompts can modify the same user interface elements.

As an example continuation of the previous example, the user may follow-up with “check at 2 instead.” In this example, the above-described procedural process can be executed by the prompt management service with additional context of 2:00 pm as the requested time. In these examples, the action suggestions can be modified to suggest the user message a different professor in respect of a different 2 pm class. In this case, the user interface may be updated to reflect a professor name substitution within a button reading “Message Professor Johnson about Missing Monday's Class.” In this manner, the system as described herein assists the user with creating content for an email messaging application. In other cases, content can be created in other ways for inclusion in other applications or application types.

The foregoing described example embodiments detail how a prompt management service can operate to select and populate sequential prompt templates to aggregate relevant context from multiple discrete applications in order to generate a complete response to a user input prompt while also providing a limited scope of possible next actions that can be taken by the user in response to the prompt. The client device can be instructed to receive input via text-to-speech and can be configured to provide output via speech-to-text so as to establish a conversational assistant platform that facilitates more organic interaction with the client device.

These architectures can result in significant reductions in cognitive overhead and time required of a user to complete a task from a client device. As a result, such architectures support rapid-fire task completion, brainstorming, and ideation. Accordingly, these systems may be described herein as “multimodal interface system applications” or “multimodal interface system platforms.”

Generally and broadly, a multimodal interface system platform as described herein includes at least a client device and a backend server or “host” server. The client device and the host server communicably couple over one or more suitable protocols to exchange information securely. In many architectures, a prompt management service as described above is a subservice of the backend, but this is not required of all embodiments. In some cases, a prompt management service as described herein can be instantiated by the client device itself.

More specific to the foregoing, a client device includes a processor and a memory. An executable asset can be stored in the memory and may be accessed by the processor. The asset, when accessed by the processor from the memory causes the memory and processor to instantiate the frontend application instance, which in turn can be configured to communicably couple to the host server, in turn including a processor and a memory (or an allocation or share of a larger order physical processor and memory) having instantiated a backend application instance. The backend and the frontend are configured for secure communications and exchange of information over, in many embodiments, industry standard communication protocols such as TCP or UDP over SSL.

The backend and/or the frontend application instance can be configured to communicably couple to one or more generative output engines. As noted above, an example of a generative output engine as described herein may be or include a LLM. Generally, an LLM is a neural network specifically trained to determine probabilistic relationships between members of a sequence of lexical elements, characters, strings or tags (e.g., words, parts of speech, or other subparts of a string), the sequence presumed to conform to rules and structure of one or more natural languages and/or the syntax, convention, and structure of a particular programming language and/or the rules or convention of a data structuring format (e.g., JSON, XML, HTML, Markdown, and the like).

More simply, an LLM is configured to determine which word, phrase, number, whitespace, nonalphanumeric character, or punctuation is most statistically likely to be next in a sequence, given the context of the sequence itself. The sequence may be initialized by the input prompt provided to the LLM. In this manner, output of an LLM is a continuation of the sequence of words, characters, numbers, whitespace, and formatting provided as the prompt input to the LLM.

To determine probabilistic relationships between different lexical elements (as used herein, “lexical elements” may be a collective noun phrase referencing words, characters, numbers, whitespace, formatting, and the like), an LLM is trained against as large of a body of text as possible, comparing the frequency with which particular words appear within N distance of one another. The distance N may be referred to in some examples as the token depth or contextual depth of the LLM.

In many cases, word and phrase lexical elements may be lemmatized, part of speech tagged, or tokenized in another manner as a pretraining normalization step, but this is not required of all embodiments. Generally, an LLM may be trained on natural language text in respect of multiple domains, subjects, contexts, and so on; typical commercial LLMs are trained against substantially all available internet text or written content available (e.g., printed publications, source repositories, and the like). Training data may occupy petabytes of storage space in some examples.

As an LLM is trained to determine which lexical elements are most likely to follow a preceding lexical element or set of lexical elements, an LLM must be provided with a prompt that invites continuation. In general, the more specific a prompt is, the fewer possible continuations of the prompt exist.

Generally, many written natural languages, syntaxes, and well-defined data structuring formats can be probabilistically modeled by an LLM trained by a suitable training dataset that is both sufficiently large and sufficiently relevant to the language, syntax, or data structuring format desired for automatic content/output generation.

In addition, because punctuation and whitespace can serve as a portion of training data, generated output of an LLM can be expected to be grammatically and syntactically correct, as well as being punctuated appropriately. As a result, generated output can take many suitable forms and styles, if appropriate in respect of an input prompt.

Further, as noted above in addition to natural language, LLMs can be trained on source code in various highly structured languages or programming environments and/or on data sets that are structured in compliance with a particular data structuring format (e.g., markdown, table data, CSV data, TSV data, XML, HTML, JSON, and so on).

As with natural language, data structuring and serialization formats (e.g., JSON, XML, and so on) and high-order programming languages (e.g., C, C++, Python, Go, Ruby, JavaScript, Swift, and so on) include specific lexical rules, punctuation conventions, whitespace placement, and so on. In view of this similarity with natural language, an LLM generated output can, in response to suitable prompts, include source code in a language indicated or implied by that prompt.

In some cases, the continuation/generative output may include format tags/keys such that when the output is rendered in a user interface, the example C++ code that forms a part of the response is presented with appropriate syntax highlighting and formatting. As noted above, in addition to source code, generative output of an LLM or other generative output engine type can include and/or may be used for document structuring or data structuring, such as by inserting format tags (e.g., markdown). In other cases, whitespace may be inserted, such as paragraph breaks, page breaks, or section breaks. In yet other examples, a single document may be segmented into multiple documents to support improved legibility. In other cases, an LLM generated output may insert cross-links to other content, such as other documents, other software platforms, or external resources such as websites.

The frontend application, backend application, and generative output engine of embodiments described herein cooperate to render custom user interfaces for users of the client device executing the frontend application. Such user interfaces present information to the user and, additionally, predict likely next actions by the user. In this manner, user interfaces are dramatically simplified.

In addition, any suitable sensor or input system of the client device can be leveraged to provide input or follow-up input by a user. For example, the user may provide voice input first and thereafter provide touch input to complete an action. In some cases, the user may provide a first voice instruction followed by a second voice instruction. In other cases, the user provides a first voice instruction, a touch input to an affordance, another voice instruction undoing an effect of the touch input, and providing a second touch input. Many input modalities and combinations thereof are contemplated herein.

In addition, any suitable output system of the client device may be leveraged to provide output to the user. For example, in some cases a text response that is responsive to a user input can be rendered as a user interface element as described above. In other cases, however, a text-to-speech system can be used to provide voice output to the user.

In this manner, a user can organically, quickly, and conversationally interact with their own information and content without requiring specialized software to interlink platforms used by a particular user on a particular device.

For example, a user may ask with a voice prompt, “do I have time to work out this morning?” From user information and context obtained from workout tracking applications installed on the user's devices (wearable devices, cellular devices, and so on), it may be determined that the user habitually runs for 30 minutes, and thereafter lifts weights for 30 minutes, requiring at least an hour of reserved time. It may also be determined from an alarm application that the user sets an alarm for 5 am. From calendar access, the prompt management service may determine that an early morning meeting has been scheduled for 7 am at the user's office, which requires on average a 20 minute commute. The service may likewise determine, via a suitable API call to a vehicle API endpoint, that the user's vehicle likely needs fuel to complete the commute. In this example, the client device may audibly respond, “Yes, there is time for a workout tomorrow but it will be close because the car needs charging.” In this example, a single input context is assembled from multiple data sources, but from a single user input provided via a voice input modality.

The client device may also render a graphical user interface with several options such as (1) show me shorter workouts, (2) send a text to a spouse to fuel the vehicle or (3) reschedule meeting at 7 am. In this example, the user may opt to select option (1) by touching a touch-sensitive input surface of the client device. In other cases, the user may ask audibly, “what are the shorter workouts?” In response, the client device can render a card depicting and/or describing a number of suitably shorter workouts for the user. In this example, the user provided input via a voice input modality despite that the user interface suggested touch or cursor input. Independent of the user's selection of input modality, the associated function can be correctly identified and performed.

In another example, a user may provide a voice prompt, “I cannot remember when I last reached out to John” From user information and context obtained from messaging, telephony and email applications installed on the user's devices, it may be determined that the user most frequently messages a particular person named John more frequently than other Johns in the user's contact list. The last message to the identified John may be found on a particular day via SMS. In this example, the client device may audibly respond, “You texted John Smith on Tuesday about a meeting on Friday.”

In this example, as with others described herein, the client device may also render a graphical user interface with multiple options such as (1) text John back to confirm Friday, (2) create calendar invite to John and myself and send, or (3) send a message to the user's assistant to coordinate a meeting with John. In response, the user may audibly respond, “Ask Steven for help here.” From user context (e.g., a contact list application and/or messages from an email application) the system may understand that Steven is the user's assistant. In response, a message can be drafted to request assistance from Steven in scheduling a meeting on Friday with John.

In yet another example, a user may desire to plan a dinner party; interactions with the system can result in a selection of a guest list, a date, a grocery list, a decoration shopping list, a recipe, and so on, all based on user-provided or -gathered information and context local to the user's device (e.g., contact lists, prior events from calendars, and so on).

These embodiments enable significantly more natural interactions with electronic devices, thereby lowering cognitive overhead associated with capturing notes, capturing ideas, recording information, and so on.

Further, in many embodiments, custom user interfaces developed/generated while interacting with a portable electronic device can be retained for future reference by a user. For example, if a user interacts with a personal electronic device to plan a dinner party, user interface elements and/or cards rendered in respect of the planning process (e.g., recipe cards, guest lists, maps, shopping lists, reminders, instructional/technique video links or previews, invitations, and the like) can be grouped together for future reference by the user. Collectively, theses simplified user interfaces and user interface elements can define a context in which the activity of planning a dinner occurred, along with metadata associated with the user's interaction with the electronic device (e.g., time of day, date, location, and so on).

These user interfaces can be gathered as cards, groups of elements, or clusters of user interface elements in an infinite or otherwise size-unbounded digital workspace that a user can navigate. In this manner, every interaction with an electronic device and application as described herein can leave memorializing breadcrumbs that can serve to remind a user of past interactions, and the results thereof. More simply, in this manner, created content (e.g., user interfaces, and user interface content) persists for a user, whereas conversations or other interactions with an electronic device are or can be transient.

In addition, collective context of user interfaces and a user's “conversation” with a system as described herein can be leveraged in the future to plan future dinner parties with more ease. More specifically, context generated while interacting with generative output engines can be aggregated and provided as a supplement to future prompts provided to future interactions with generative output engines.

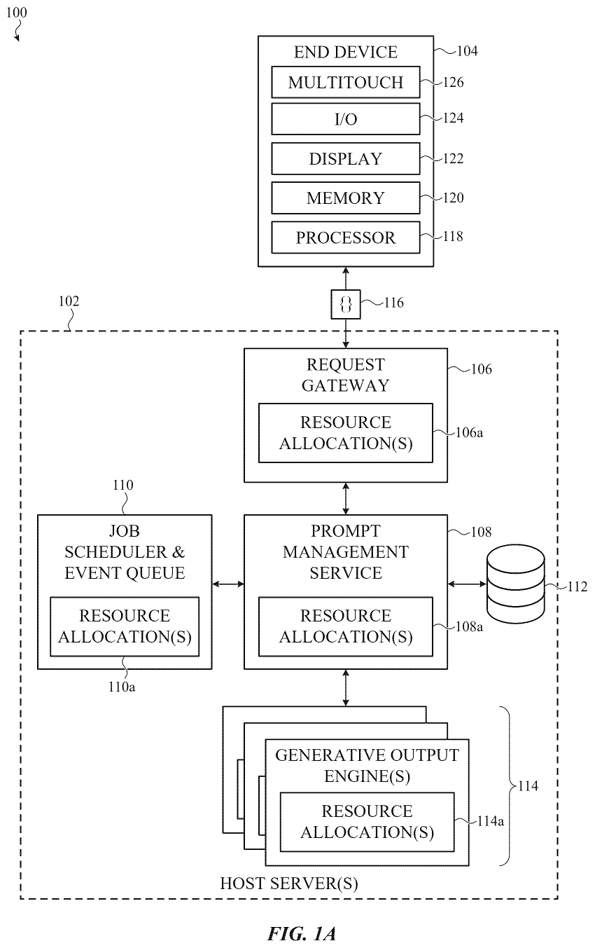

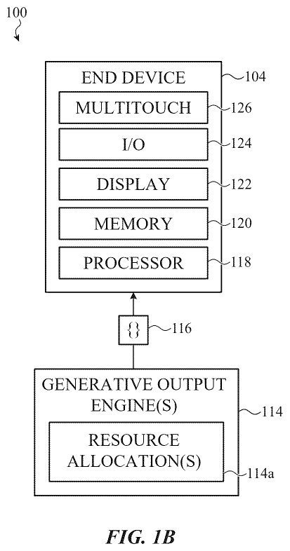

These foregoing and other embodiments are discussed below with reference to FIGS. 1-4. However, those skilled in the art will readily appreciate that the detailed description given herein with respect to these figures is for explanation only and should not be construed as limiting.

FIG. 1A depicts a system for leveraging large language model output for rendering user interfaces to define a multimodal interface system application as described herein.

The multimodal interface system 100 includes a backend system and a frontend, as with other embodiments described herein. The frontend system communicably couples to the backend system to exchange information therebetween.

In particular, the backend system is instantiated in whole or in part by operation of a host server 102. The host server 102 can include processor resources and memory resources that can be allocated to particular virtual machines or software instances. In many cases, the host server 102 is a single computational element, but in other cases, the host server 102 may be an aggregate computing resource, including a number of physical processors, memory, and network couplings that can be allocated on demand to different processing or instantiation tasks. The host server 102 is configured to communicably couple over a network to a endpoint device 104.

The endpoint device 104 can be any suitable electronic device, and may be personal to a user. Example electronic devices include, but are not limited to laptop devices, wearable devices, desktop devices, tablet computing devices and the like. More broadly, the client device can be any suitable computing resource—including portable electronic devices—configured to communicably couple and network to the host server 102.

The host server 102 includes several discrete services that may be implemented as physical hardware appliances or instances of software executing over dedicated or shared virtual resource allocations.

In particular, the host server 102 includes in many embodiments a request gateway 106 configured to receive one or more requests form the endpoint device 104. More specifically, the request gateway 106 can be configured to receive and route API requests or HTTP requests (or other suitable requests) originating from the endpoint device 104 to appropriate backend services of the backend system supported by the host server 102. The request gateway 106 can be implemented as a reverse proxy, a query gateway, a firewall, or any other suitable security or routing appliance.

The request gateway 106 can be supported by a resource allocation 106a, which may include virtual or physical processing and memory resources that can cooperate to instantiate an instance of software that performs, coordinates, or otherwise executes a task or function of the request gateway 106.

The request gateway 106 can be configured to couple to a prompt management service 108. As with the request gateway 106, the prompt management service 108 can be configured to receive and route API requests or HTTP requests (or other suitable requests) originating from the request gateway 106 (forwarded form the endpoint device 104). The prompt management service 108 can be supported by a resource allocation 108a, which may include virtual or physical processing and memory resources that can cooperate to instantiate an instance of software that performs, coordinates, or otherwise executes a task or function of the prompt management service 108.

The prompt management service 108 can be operably coupled to one or more services. For example, as noted above, the prompt management service 108 can be configured to receive code snippets that can be packaged as work items added to a work item queue to be executed at a particular time, in parallel, or in sequence by a worker node, virtual machine, or other code execution environment. In many cases, the work items can be added to a job queue 110, that like other subservices or functions of the backend system can be supported by a resource allocation 110a, that may include virtual or physical processing and memory resources configured to cooperate to instantiate an instance of software that performs, coordinates, or otherwise executes a task or function of the job queue 110.

The prompt management service 108 can also be operably coupled to a database such as a prompt template database 112. The prompt template database 112 can store one or more prompts, prompt sets, prompt execution plans, or the like. In many examples, engineered prompt templates can include tag-delineated tokens that can be replaced by the prompt management service 108 or another subservice of the backend system.

For example, as noted above, some templates stored by the prompt template database 112 can include a token into which a user's name may be inserted. In these examples, the prompt management service 108 can be configured to replace the token with the user's name. In other cases, the prompt management service 108 can be configured to insert any other suitable information to provide context in respect of the user. Example information can include, but may not be limited to: personal identification information (e.g., names, social security numbers, telephone numbers, email addresses, physical addresses, driver's license information, passport numbers, and so on); identity documents (e.g., drivers licenses, passports, government identification cards or credentials, and so on); protected health information (e.g., medical records, dental records, and so on); financial, banking, credit, or debt information; third-party service account information (e.g., usernames, passwords, social medial handles, and so on); encrypted or unencrypted files; database files; network connection logs; shell history; file system files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

In addition, the prompt management service 108 can be configured to collect and insert contextual information in respect of the endpoint device 104. For example, the prompt management service 108 can populate a template retrieved from the prompt template database 112 with: an operating system of the endpoint device 104; a number of installed applications of the endpoint device 104; a listing of application names of the endpoint device 104; a list of services accessible to the endpoint device 104; a list of hardware available to the endpoint device 104; a screen size of the endpoint device 104; a display type of the endpoint device 104; input modalities available to the endpoint device 104 (input systems, sensors, and the like); and so on. Generally and broadly, information about the endpoint device 104 and/or metadata describing emergent properties of the endpoint device 104 may be inserted by the prompt management service 108 into a template obtained form the prompt template database 112.

As noted above, the prompt management service 108 is further configured to, after modifying and/or populating a template retrieved from the prompt template database 112 to provide that template as input to a generative output engine, or one or more generative output systems or platforms. Collectively, these systems are identified as the generative output engines 114.

In some cases, the generative output engines 114 are separate to the backend system, and may be managed by one or more third parties. In other cases, such as shown in FIG. 1, the generative output engines 114 can be instantiated by the host server 102. In these examples, the resource allocation 114a can support instantiation and execution of the generative output engines 114.

In the illustrated architecture, the endpoint device 104 can transmit a request via TCP or HTTP or another suitable protocol, as a structured data object (e.g., the structured data 116) to the host server 102. The structured data 116 can be received at the request gateway 106 which forwards the structured data 116 or a portion thereof to the prompt management service 108 for processing.

The prompt management service 108 can receive the structured data 116 and extract content corresponding to an input provided by a user to the endpoint device 104. The input may be received via a text interface of the endpoint device 104, via a voice interface of the endpoint device 104, or from another input modality.

Thereafter, the prompt management service 108 can retrieve from the prompt template database 112 one or more prompt templates that, once executed can provide a basis for generating a simplified user interface responsive to the user input provided to the endpoint device 104. As with other examples described herein, the prompt management service 108 can be configured to populate the retrieved prompt templates with user-specific information, with device-specific information, or any other contextualizing information. For example, in some cases, the user may provide a file, photo, or other document for upload to the host server 102 that may likewise be included as context within a prompt template populated by the prompt management service 108.

After populating a template prompt, the prompt management service 108 can provide the template as input to the generative output engines 114 and may receive a stream or chunked output. In some cases, the output may include executable code, from which the prompt management service 108 can construct one or more work items to add to the job queue 110. In other cases, the output may include HTML elements suitable for rendering in a graphical user interface of the endpoint device 104. In other cases, the output may contain information used by the prompt management service 108 to select and/or populate another template prompt for processing by the generative output engines 114.

As noted above, the prompt management service 108 can be configured to request the generative output engines 114 for one or more likely actions to be taken by a user in response to a particular continuation of the user's input prompt. For example, if the user is not available for a particular meeting, predicted next actions may include rescheduling an existing meeting, cancelling an existing meeting, finding a new time for a proposed meeting, and so on.

Output of the generative output engines 114 and/or predicted actions output by the generative output engines 114 can inform and/or be associated with requests to generate individual user interface elements to be rendered for the endpoint device 104. In some cases, text information can be rendered in a text field whereas user interaction soliciting affordances can be rendered via a button element. A person of skill in the art may appreciate that many constructions are possible.

Once the prompt management service 108 requests the generative output engines 114 to generate one or more user interface elements, a response can be transmitted from the host server 102 to the endpoint device 104 such that the endpoint device 104 can render the user interface for the user. As noted above, each user interface element can be assigned a unique identifier by the prompt management service 108 or the generative output engines 114, which can be used to update the content of that respective user interface element in response to future requests or follow-ups by the user. The unique identifiers can likewise be used to synchronize outputs of different modalities so as to provide a single combined output context for a user. For example, a voice output generated form generative output can be synchronized in time with a unique identifier associated with a particular user interface element rendered in the user interface at the same time. For example, a voice output may include a demonstrative pronoun, such as “this” in a phrase such as “select this element if you′d like to schedule an appointment.” In the example, the time at which the term “this” is output by the device, a user interface element identified by a unique identifier specific to that element may be emphasized, animated, or otherwise highlighted for the user. Such dynamic and ad hoc coordination of multiple nondeterministic output modalities cannot be performed by conventional systems.

More broadly, the endpoint device 104 can be configured as described herein to sense multiple inputs via multiple modalities and to provide output to a user via multiple output modalities. For example, the endpoint device 104 can include multiple sensors such as touch sensors, force sensors, microphones, position sensors, cameras, IMUs, gyroscopes, accelerometers, and the like. Similarly, the endpoint device 104 can include multiple output systems such as but not limited to speakers, haptic output systems, audio output systems, wheels, motors, actuators, displays, tilting or repositioning surfaces, articulating joints, and the like.

In these examples, the endpoint device 104 can be configured to collect and aggregate a time series of input events, which can be provided as input to a prompt management service as context in which a particular prompt or series of prompts is processed. For example, as noted above, a user may provide voice input and touch input simultaneously, each of which references or is associated with a portion of context necessary to understand a user intent. For example, a user may touch a user input affordance and provide an instruction with a demonstrative pronoun such as “this” or “these.” By combining context for the prompt management service 108 in this manner, the prompt management service 108 can provide more relevant input to the generative output engines 114 which in turn can provide more accurate and responsive outputs to a user of the endpoint device 104.

In addition to multimodal input, the multimodal interface system 100 can be configured for multimodal output. Specifically, the endpoint device 104 can include multiple output systems that can be leveraged to provide responses to a user in different contexts. For example, the prompt management service 108 may populate a prompt that instructs the generative output engines 114 to generate a structured data output to inform operation of multiple output systems, such as a display, a speaker, and/or an actuator. In some examples, content can be rendered on the display simultaneously with a description of that content being played back via the speaker. In other cases, a voice output can accompany an animation on the screen emphasizing a particular affordance or group of affordances.

It may be appreciated that different contexts may warrant different outputs. For example, in some cases, the prompt management service 108 may determine by operation of the generative output engines 114 that only visual output should be provided if sampling of a microphone of the endpoint device 104 indicates a noisy or public environment. In other cases, if sampling of the microphone indicates a quiet and/or private environment, a greater quantity of voice output can be provided. In this manner, in some embodiments, the prompt management service 108 can be configured to select a ratio or proportion of different types of output or different modalities of output. In some cases, 100% visual output can be provided. In other cases, 100% haptic output can be provided (e.g., in a darkened environment, such as a movie theater). In yet other examples, a user's interactions with the endpoint device 104 can inform context. For example, if the user is listening to music or watching a video, a visual notification may be more appropriate than a haptic notification or audio notification. The foregoing examples are not exhaustive; many examples and ratios among different output modalities are possible.

The endpoint device 104 can include a number of components enclosed in a housing. For example, the endpoint device 104 can include a processor 118, a memory 120, a display 122, an audio system 124, and/or one or more input sensors such as a multitouch input device 126. In many embodiments, the endpoint device 104 is a tablet device without a touch screen, but this is not required in all cases. The endpoint device 104 can instantiate a frontend application, such as a browser application or native application, by cooperation of the processor 118 and the memory 120. The frontend application can be configured to communicably couple to the host server 102, as described above, to receive graphical user interface elements to render, to receive text to convert to audio, and/or to provide other output to use in response to user input provided to the endpoint device 104.

These foregoing embodiments depicted in FIG. 1A and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that in some embodiments, a prompt management system or prompt manager may not be required. More particularly, an end-to-end neural network may be trained to provide, coordinate, or otherwise support one or more operations of a multimodal input/output system as described herein. For example, a neural network can be trained to receive, as input, multimodal user information, and to provide as output one or more prompts that can be provided as input to one or more generative output systems as described herein. In these and related embodiments, the same or a different neural network can be trained to receive, as input, output from a generative output system and to provide, as output one or more structured data objects that can be consumed by an end user device to generate a user interface, to instruct a haptic output, and/or to provide any other single mode or multi modal output.

In yet other embodiments, a prompt management service function as described above can be implemented in whole or in part as a trained machine learning model configured to automatically integrate with one or more systems, databases, or APIs so as to automatically perform user-specific, device-specific, and/or task-specific retrieval augmented generation when cooperating with a generative output system as described above.

In still further embodiments, a system as described herein can be trained to perform end-to-end support of multimodal input and multimodal output as described above; in such examples a single system and/or ML instance may be configured to receive multiple user input streams as input and can be configured to provide, as output, one or more instructions to be received and acted upon by one or more devices, such as client devices of the user. For example, FIG. 1B depicts a simplified topology in which the endpoint device 104 communicably couples directly with the generative output engine 114, as described herein.

Generally and broadly, it may be appreciated that one or more functions described above and elsewhere herein can be performed in whole or in part by purpose configured software instances and/or purpose trained ML instances, or a combination thereof.

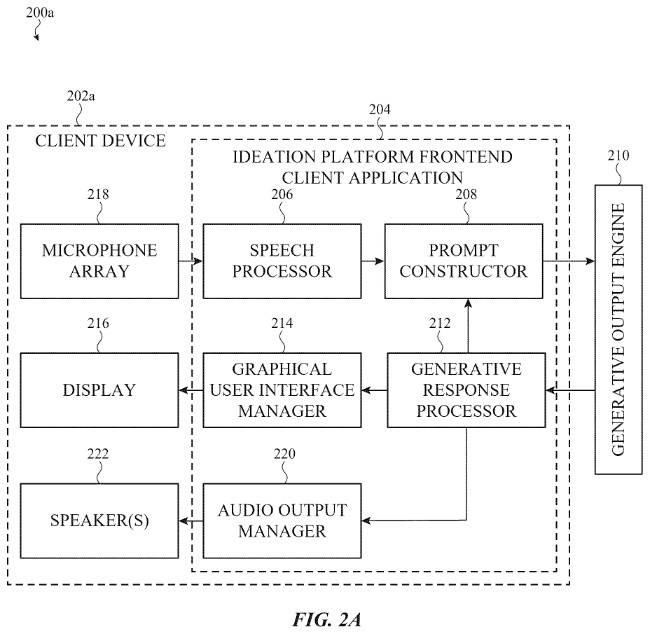

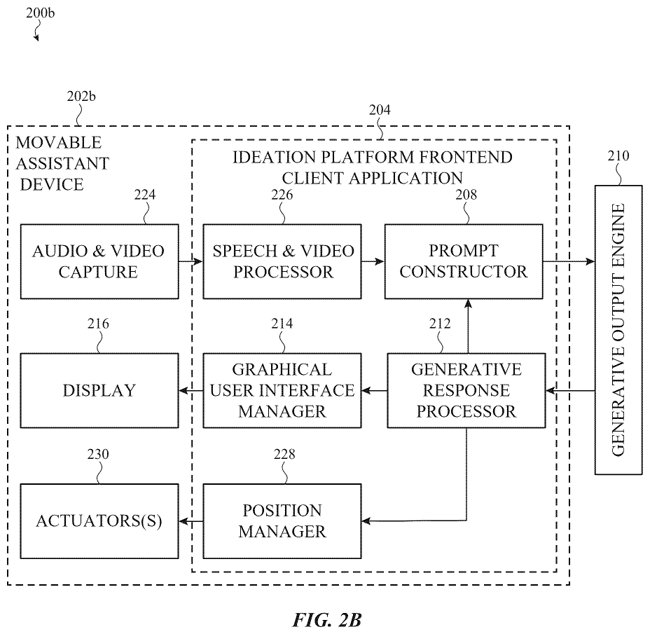

For example, in some cases, a prompt management service may be instantiated by a client device. FIGS. 2A-2B each depict a simplified schematic diagram of a multimodal interface system application instantiated by a client device, as described herein.

In the illustrated embodiment, the platform 200a includes a client device 202 upon which is instantiated an ideation platform application instance 204. The ideation platform application instance 204 can include a speech processor 206 and a prompt constructor 208. The speech processor 206 can be configured to receive audio input from a user of the client device 202 and to convert that audio input into structured text output.

The prompt constructor 208 of the ideation platform application instance 204 can be configured to generate one or more prompts and/or populate one or more prompts based on the output of the speech processor 206. As with other embodiments described herein, the prompt constructor 208 can be configured to access a local or remote database that includes and/or contains one or more prompt templates that can be populated with user information, device information, or other useful contextual information.

The prompt constructor 208 can be communicably coupled to a local or more generative output engine, such as the generative output engine 210. As with other embodiments described herein, the generative output engine 210 can provide a response to the prompt that may be received by a generate response processor 212. The generate response processor 212 can be configured to determine whether to provide output back to the prompt constructor 208 or provide output to a graphical user interface manager 214 so as to generate a custom user interface as described herein.

The graphical user interface manager 214 can be coupled to a display 216 of the client device 202 so as to render a graphical user interface informed by output of the generative output engine 210. In this example, a user of the client device 202 can provide audio input (e.g., via providing an instruction to a microphone array 218), which is converted to text by the speech processor 206, inserted into an appropriate template by the prompt constructor 208, provided as input to the generative output engine 210, received as a continuation or generative output at the generate response processor 212, which in turn can be used by the graphical user interface manager 214 to render a graphical user interface over the display 216.

In some cases, the generate response processor 212 can be configured to extract from a response from the generative output engine 210 a descriptive or narrative string that can be passed to an audio output manager 220, which in turn can provide text-to-speech voice output to a user via the audio output system 222. In this example, a user of the client device 202 can provide audio input (e.g., via providing an instruction to a microphone array 218), which is converted to text by the speech processor 206, inserted into an appropriate template by the prompt constructor 208, provided as input to the generative output engine 210, received as a continuation or generative output at the generate response processor 212, which in turn can be used by the graphical user interface manager 214 to render a graphical user interface over the display 216, while contemporaneously a narrative description is extracted by the generate response processor 212, passed to the audio output manager 220, which causes the audio output system 222 to produce speech output.

These foregoing embodiments depicted in FIGS. 1-2A and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, FIG. 2B depicts a systems diagram similar to FIG. 2A in which a device includes multiple physical components that feed information to and/or receive output from a prompt constructor and/or generative output engine. FIG. 2B depicts a movable assistant device 200b that includes an ideation platform application instance 204, the prompt constructor 208, the generative output engine 210, the display 216, the graphical user interface manager 214, and the generate response processor 212 as described above. In this example, however, the system also includes n audio and video capture system 224 that can include cameras and microphones that feed information or samples or digital data into a speech and video processor 226. The speech and video processor 226 can be configured with one or more graphics processing units and/or tensor processing units to assist with processing tasks associated with object recognition, facial recognition, or other video or audio based recognition task.

The system also includes one or more actuators such as wheels, pivots, motors, pistons, linear actuators, and so on that can control a position, pose, orientation, or placement of a housing of the movable assistant device 202b. Specifically, in this example, output from the generative output engine 210 can be provided as input to a position manager 228 that similar to the graphical user interface manager 214 and the audio output manager 220 (of FIG. 2A) can be configured to process output of the generative output engine 210 to inform control of one or more actuators 230.

These foregoing embodiments depicted in FIGS. 1-2B and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

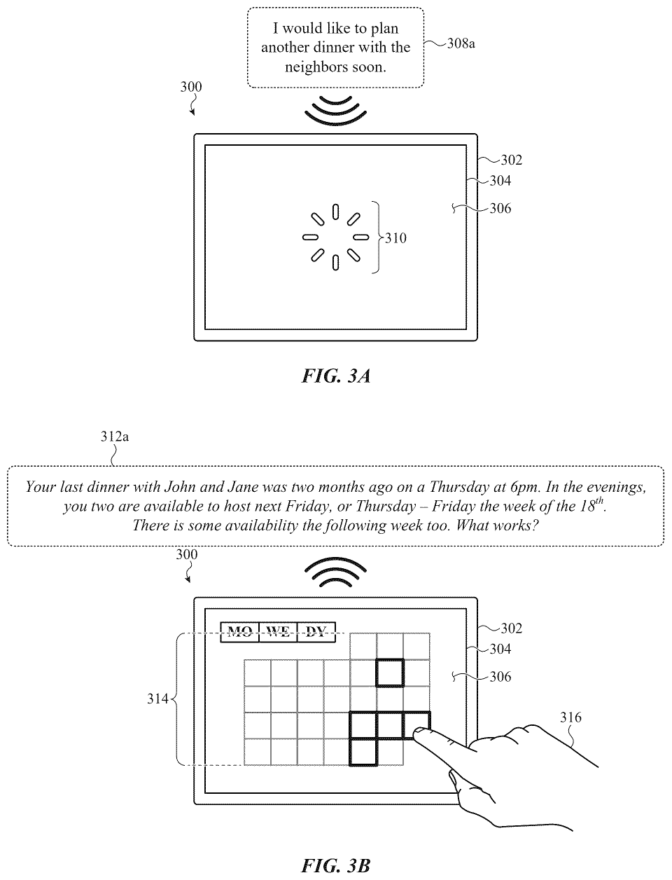

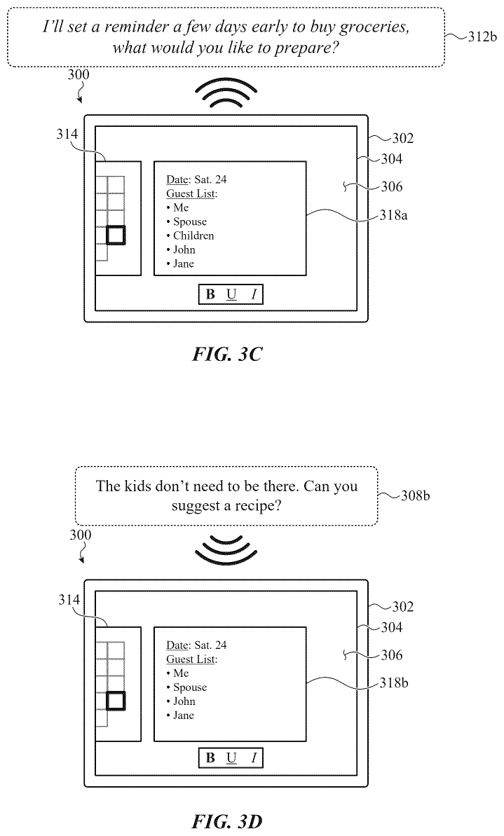

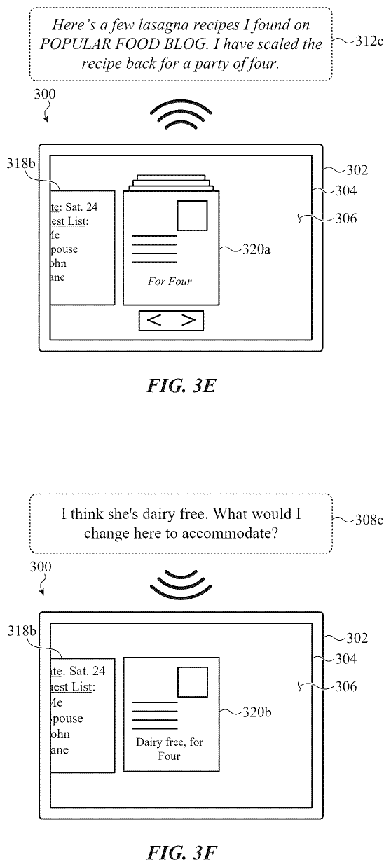

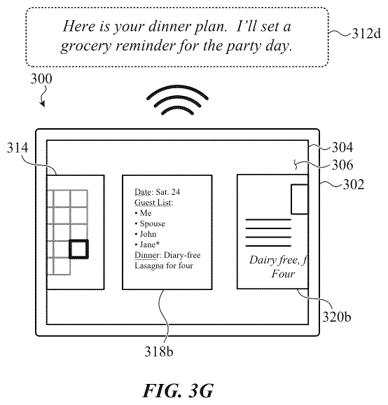

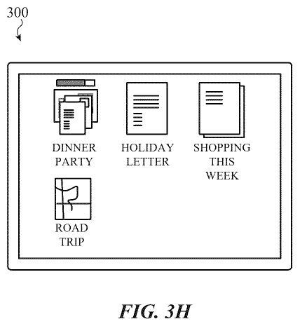

FIGS. 3A-3H depict a sequence of graphical user interface modifications that can result from interaction with a multimodal interface system application, supported by textual output of one or more large language models, as described herein.

The client device 300 is a tablet device, but this is merely one example. The client device 300 can include a housing 302 that encloses and supports a display 304. A frontend application instance executing on the client device 300 can leverage the display 304 to render a graphical user interface 306.

The client device 300 can include on or more microphones and speakers to receive voice input from and to provide voice output to a user of the client device 300. In addition, the client device 300 can include a touch input sensor coupled with the display 304 so as to receive touch input form a user. Broadly, many input modalities can be supported by the client device 300.

In the illustrated example shown in FIG. 3A, the graphical user interface 306 of the client device 300 depicts a processing indication 310 indicating to a user of the client device 300 that the frontend application is ready to receive user input (e.g., an initial prompt). The user may provide the response via a voice instruction, such as the input voice prompt 308a. In the illustrated example, the input voice prompt 308a includes a statement of “I would like to plan another dinner with the neighbors soon.”

As with other embodiments described herein, the client device 300 can be configured to communicate with and/or leverage a prompt management service to populate a series of template prompts that result in (1) a characterization of the user's intent to organize and plan a dinner party with persons identified as neighbors, (2) a series of API calls to contact applications or services, messaging applications or services, calendaring applications or services to obtain information relevant to the expected intent, (3) receive results of each constructed API call, and (4) with aggregate context generate a response to the input voice prompt 308a that includes instructions for rendering a graphical user interface and a non-graphical response, such as a output voice response 312a as shown in FIG. 3B.

In some cases, generated graphical user interface elements and/or modifications to existing graphical user interface elements can be streamed to the graphical user interface 306 (depicting progressive rendering of the user interface updating in real time), whereas in others, changes to a graphical user interface can be animated and/or rendered only when a generative output engine has provided a complete output and that output has been parsed by a prompt management system as described herein. In many cases, specific user interface elements and affordances can be rendered alongside custom user interface elements. For example, as shown in FIG. 3B, a view selector interface element can be rendered alongside a calendar view 314 so that the user can modify how the calendar is displayed. More broadly, it may be appreciated that useful user interface elements relevant to the context in which a user is interacting with a particular user interface or card can be rendered; if editable text is shown, text manipulation and/or formatting controls may be shown, whereas if a picture is shown, one or more image manipulation controls can be shown, whereas if a task list is shown one or more task completion or annotation controls can be shown, whereas if a web view is shown one or more web navigation tools can be shown. Context can vary from view to view or embodiment to embodiment, an contextually-appropriate user interfaces, user interface tool bards, and the like can be dynamically created and/or shown when contextually appropriate.

In the illustrated example, a graphical user interface element such as a calendar view card 314 can be rendered to assist the user 316 with visualizing and selecting a date for the proposed dinner party.

When presented with this information the user 316 may provide a follow-up input by engaging an affordance rendered within the calendar view card 314 to select a date. This follow-up input, and the date associated therewith, can be appended as context to subsequent prompts constructed by the prompt management service.

In this example, the user 316 provides an input by touching the display 304, to engage with a particular date rendered within the calendar view card 314. It may be appreciated that this interaction paradigm is different from the first interaction paradigm in which the user 316 provided the input voice prompt 308a. For embodiments described herein, the graphical user interface rendered in respect of a series of constructed API calls and/or prompts of generative engines can be manipulated and/or engaged in different ways. Specifically, the user may speak, touch, or provide another input or combination of inputs.

For example, in some cases, while the user 316 is providing a touch input, the user may also provide a voice output of “this day.” In response, the client device 300 can determine that the user has provided two separate indications of a selection of a particular date on which to schedule the dinner party. In other cases, the user 316 may not provide a contemporaneous voice input at all, but instead may simply engaged the graphical user interface 306 by touching. In yet other examples, the user may only provide a voice input, such as by saying “none of these will work” or similar. In response the client device 300 may cause a prompt management service to generate additional or separate suggestions for updating the calendar view card 314. In these examples, more simply, it may be appreciated the user may interact by “showing” the client device which element is selected and/or “telling” the client device which element is selected.

For example, as shown in FIG. 3C, a second series or sequence of prompts organized by a prompt management service as described herein can result in a graphical user interface 306 in which the calendar view card 314 is shifted so as to render a summary view card 318a. The summary view card 318a can include information such as the user's selected date (in the illustrated example, Saturday the 24th) and other information generated by a generative output engine, including expected guests. Upon rendering the updated graphical user interface in this example, the client device 300 can be configured to contemporaneously provide an output voice response 312b, again contextualizing the update to the graphical user interface 306 as rendered in the display 304.

In other cases, the graphical user interface 306 can be automatically adjusted to reflect new context, new information, new user requests and/or new user content. For example, a system as described herein can be configured to move cards, close cards, dismiss notifications, dismiss cards, animate cards, increase transparency, decrease transparency, resize cards or element, scroll within a card or within a workspace or canvas area including multiple cards, group two or more cards into a stack, re-group cards from multiple stacks, zoom into content of a particular card or portion of a card, mask a portion of a card to emphasize content or a portion thereof, generate a popover/popup/modal window to convey a notification or short-turn contextual information, and the like. Broadly, a system as described herein and in particular a graphical user interface 306 as described herein can be dynamically manipulated in response to output from a generative output engine so as to emphasize particular content, facilitate convenient access to particular content, assist a user in generating content relevant to other content, and the like.

As with other cards described herein, the summary view card 318a can be rendered with text controls or other custom user interface elements that encourage a user to interact with the content in multiple ways. More specifically, the graphical user interface elements inform the user that the user can modify the automatically-generated content shown in the summary view card 318a.

Although FIG. 3B depicts a user providing follow-up input via touch input, it may be appreciated that this is merely one example; other input modalities may be used to provide input and/or follow-up input to the client device 300 as described herein. For example, as shown in FIG. 3D, the user may provide an input voice prompt 308b that requests to adjust the guest list as proposed by the generative output engine. In response, the prompt management service can cause the graphical user interface 306 to update the summary view card 318a into the summary view card 318b, in which the requested change to the guest list is made. This update to the graphical user interface 306 can be performed by prompt management service assigning unique identifiers to each graphical user interface element, as described above.

In other cases, a voice prompt may not be required to interact with the system. For example, a user may touch the word “Children” as shown in FIG. 3C and contemporaneously provide a voice input of “they're at their grandparents.” In response to the two inputs (a touch input to a user interface element showing “Children” within the summary view card 318a and a voice input to the client device 300), a prompt can be constructed with the dual context that causes a generative output engine to update the summary view card 318a to remove the children from the guest list.

Such interactions, as may be appreciated, are not possible in conventional generative input/output systems, as a single touch input does not provide an instruction for a generative output system to perform any task and similarly a voice instruction including a pronoun reference “they” does not provide sufficient context for a generative output system to understand what task should be performed. However, by combining context of multiple input modalities, a combined context can be provided in embodiments described to cause the summary view card 318a to be updated as organically instructed by the user.

In other cases, the user 316 may engage with the calendar view card 314 as partially shown in FIG. 3C or FIG. 3D. In these examples, the graphical user interface 306 may cause the calendar view card 314 to be focused so that the user can provide further input in respect of the selected date. More specifically, the user may in some examples, interact with already-created content (e.g., the calendar view card 314 and the date selected therefrom) so as to change the content that in turn was previously used as context to generate other content. More simply, if the user “goes back” to modify the calendar view card 314, the summary view card 318a can likewise be updated to reflect a newly-selected date. More simply, as the graphical user interface 306 is not immutably linear or procedural, a user such as the user 316 can interact with created content in any suitable non-linear fashion.

In yet other examples, selection of a guest name as shown in FIG. 3C can present a user-editable text field so that the user can manually edit the guest list. In some cases, selection of a guest name can be by voice prompt (e.g., “edit the children line”) or by selection via the graphical user interface 306. Selection via the graphical user interface 306 can be by touch input, force input, cursor input, keyboard input, or any other suitable input modality.

In response to an indication from the user that manual editing of the guest list is completed (in which the user may add new lines and new guests, may remove guests, or may edit lines to correct spelling or to replace names with nicknames or informal names), context in respect of the prompts and prompt sequences can be updated. In some cases, the user may press a “return” button on a keyboard to indicate an end to manual editing. In other cases, a timeout period may pass. In some cases, the user may type manual updates whereas in others dictation may be leveraged.

In addition, in some embodiments, the input voice prompt 308b (or other user provided prompts) can include multiple instructions or questions. In this example, a first instruction is provided to amend the guest list. In addition, the input voice prompt 308b includes a secondary instruction to suggest recipes. In these examples, the prompt management service may be configured to execute two or more sequences or series of prompts, such as described above.

For example, as shown in FIG. 3E the client device 300 can provide another voice output, the output voice response 312c, and render another graphical user interface element such as the recipe view card 320a, causing the summary view card 318b to be relocated or otherwise shifted out of view. In some cases, the recipe view card 320a can be shown in a stack with other retrieved recipes that the user can iteratively select. In other cases, a stack can be rendered to retain history of a particular content item such as the recipe view card 320a; as the card becomes modified by user and computer interaction, historical state information in respect of the recipe view card 320a can be accessed via selected the stack rendered behind the recipe view card 320a.

As shown in FIG. 3F, the user may provide additional input and context as the input voice prompt 308c, indicating that one guest to the planned dinner party may not prefer the suggestion shown in the recipe view card 320a. In response, the system can cause the recipe view card 320a to be modified to a modified recipe view card 320b. Once the user is satisfied with the interaction with the client device 300 (i.e., further inputs are not received), the graphical user interface 306 can automatically transition back as shown in FIG. 3G to a view in which the summary view card 318b is centered, displaying a selectable portion of the calendar view card 314 and the modified recipe view card 320b for selection and/or review by the user. Contemporaneous with modifying the user interface in this manner, the client device 300 can be instructed by the prompt management service to provide the output voice response 312d, indicating additional operations performed by the system on behalf of the user.

These foregoing embodiments depicted in FIGS. 3A-3G and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

For example, it may be appreciated that multiple tasks can be accomplished with the multi-card interface as described above. In some cases, multiple discrete tasks can be performed at the same time and/or in parallel. In these examples, the client device 300 can be configured to render a workspace view that shows a graphical representation of two or more “projects” that the user has accomplished. FIG. 3H provides an example user interface showing multiple discrete stacks of cards, each stack memorializing content created in respect of a user's interaction with the client device 300.

In some cases, a task performed by a system as described herein can include instantiation of one or more agents configured to perform a multi-step task for the benefit of a user. For example, continuing the dinner party example above, an agent may be instantiated to order a dessert for the dinner party on a particular day. In these examples, an agent may be deputized with authority to approve purchases for the user and/or to engage with one or more services or vendors on behalf of the user. In some cases, an agent's progress can be rendered within a graphical user interface as described herein, such as shown above the “DINNER PARTY” card stack shown in FIG. 3H.

A person of skill in the art may appreciate that an agent can be configured to perform any suitable long-run task. Similarly, agent progress and/or agent questions or clarifications (or approvals) can be communicated to a user in a number of suitable ways. For example, when ordering a cake on behalf of a user, an agent may be configured to request payment authorization of the user, ingredient substitutions required by a vendor or baker, or the like. These agent interactions can be performed and/or coordinated via the client device 300 or another device of the same user. For example, an agent can be configured to call or notify a user via a cellular phone; many constructions are possible.

An agent can be implemented in a number of suitable ways. In some examples, an agent may be an instance of software configured to select a job from a job queue such as the job queue 110 as shown and described in respect of FIG. 1A. In other cases, an agent may be a virtual computing instance instantiated over cloud infrastructure that is configured to schedule, coordinate, perform, and report results and/or progress of one or more tasks requested by a user and/or requested to be performed on behalf of a user.

For example, an agent can be deployed to complete a long-run task requested by a user. Continuing the previous example, the agent may be configured to coordinate ordering food for the dinner party planned in respect of FIGS. 3A-3G. In this example, the agent can be configured to generate or cause to be generated one or more prompts to suggest one or more vendors to contact to solicit information about ordering required food. For example, a prompt may be “provide as output a list of string queries that can be provided as input to a mapping application to request a list of {{food.type}} restaurants that cater and deliver to {{user.location}}.” In response to execution of a prompt, a list of queries may be provided as output that in turn can be provided to a mapping service to return a list of possible restaurants. Thereafter, the agent can be configured to contact each restaurant (e.g., via email, via social media, and/or via voice interaction over a telephone) to obtain pricing information, timing information, allergy information, and the like from each respective restaurant. Upon receiving results from each restaurant, and/or upon occurrence of a timeout (e.g., 24 hours), the agent can determine which restaurants are likely to be of interest to the user to order food for the planned dinner party.

In some embodiments, an agent as described herein can be configured to complete an entire task without supervision or input from a user. In other cases, the agent's operational plan and/or job plan can include one or more automatic checkpoints and/or callbacks to a user to determine whether the agent should proceed.

For example, a food ordering agent may be configured to request permission from a user to perform a financial transaction. In other cases, an agent can be configured to request permission from a user to complete a transaction only if the transaction amount exceeds a certain agent-specific or user-configured per diem or per-transaction threshold. In yet other examples, the agent can be configured to request permission of multiple users to complete a transaction. For example, an agent may be configured to obtain permission from two spouses in order to complete a dinner party food order.

A callback or checkpoint can take a number of forms. In some examples, an agent can cause to be transmitted to a user device such as a cell phone a notification that solicits input and permission from the user to continue. The user can receive the notification, and provide authorization in response thereto. The user's authorization can cause the user device to cause to be transmitted back to the agent a token (e.g., JWT or similar token) that authorizes the agent to perform and/or complete the requested action.

In other cases, a modal or popup user interface can be displayed by the client device 300. As with a notification transmitted to a mobile device, the user may interact with this notification in order to provide requisite permission.

In yet other cases, the client device 300 can cause the display to reposition, resize, rearrange, or otherwise shift focus to display a card or other content item relevant to the permission request. In some cases, the display 304 can render a new card in respect of the permission request itself. For example, a new card can be rendered that describes the transaction, describes vendor restrictions and/or timetables, provides a description of the services or goods to be purchased, and the like. In addition, acceptance or declination buttons can be rendered within the graphical user interface 306. In response, the user may provide touch input, voice input (e.g., “approved” or “yes” or “that's fine”), or any other suitable input to indicate an intent to interact with either rendered button/affordance. In response, as noted above, the respective agent (or set of agents) can be notified or otherwise informed that permission has been granted or denied.

In response to a denial of permission, an agent may stop work or adopt a different technique or plan to accomplish the assigned job. Many constructions are possible.

The foregoing examples are not exhaustive. In some embodiments, an agent can determine and/or schedule its own callback points or checkpoints. In some cases, a prompt management system can determine callback points for an agent. In some cases, a user preference (e.g., stored in user preference file or similar) can inform one or more agent checkpoints. In some cases, a first agent may require a checkpoint answer from another agent. For example, a food ordering agent may be required to check-in with a transaction management agent to determine whether a budget for a particular purchase has been set, exceeded, or approved of by a user.

Similarly, the foregoing listed example of a checking to verify a financial transaction approval is merely one example. In other cases, other checkpoints can include but are not limited to: rescheduling requests; substitution approvals; ingredient or allergy checks; reports of unexpected events; installing software updates; changing home automation settings; authorizing charging of a vehicle; and the like.

In many cases, an agent can provide status updates to provide a user with information about progress of a long-run task. For example, an agent can be configured to report a percentage complete of a particular task based on a proportion of completed tasks among a set of tasks to be completed by the agent. In other cases, a progress report may be made to reflect estimated progress of a vendor or other third party. For example, an agent may determine from interactions with a vendor that the vendor is likely to be finished in N hours or M time. In this example, the agent may initiate a timer, and report percentage completion of the timer.

In yet other example, an agent may check in with a user at particular progress points. For example, the agent may check in with a user upon completion of 50% of tasks with a set of tasks. In other cases, the agent may report progress at a particular time of day.

In some cases, progress can be reported via a notification to a device, a modal dialog, a voice alert, a haptic alert, an email, an SMS message, a telephone call, a message to a third party (e.g., a personal assistant of the user) and the like. Many configurations are possible.

Further to the foregoing examples, a system in which a user performs multiple tasks such as shown in FIG. 3H can be configured to separate context into relevant tasks. For example, if a user planning a dinner party states, while planning that party, “add this dinner party to the holiday letter”, the system can be configured to—in parallel with planning activities—make an addition to a separate and discrete project called “holiday letter” (see, e.g., FIG. 3H). More simply, a user providing multimodal input may have such input parsed into multiple discrete contexts or into a single context. Discrete contexts can in turn be associated with discrete prompts or sets of prompts as described herein.

For example, it may be appreciated that the graphical user interface as shown in FIGS. 3A-3H can include any number of groups of cards, each of which is associated with a different task completed by the user through interaction with the device. In this manner, the graphical user interface can define an infinite or otherwise unbounded workspace in which cards or other collections of user interface elements are shown in logical groups, each card including only those affordances or informative user interface elements that are or may be required for a user to interact.

Generally and broadly, it may be appreciated that any suitable number of tasks can be performed, coordinated, or organized by system as described herein.

Further, as noted above, a system as described herein can be configured to not only present and organize information for a user, but such a system can be likewise configured to manipulate a graphical user interface to rapidly present relevant information to a user. For example, in some cases, a system as described herein can be configured to manipulate a graphical user interface by moving elements or cards, shifting elements or cards, closing elements or cards, dismissing elements or cards, resizing elements or cards, scrolling within elements or cards, scrolling or repositioning within an area that contains elements or cards or groups thereof, grouping elements or cards, rendering a popover or modal window above elements or cards, rendering informational windows, and the like.

In further examples, a system as described herein can be configured to provide relevant information to a user while that user is performing another task. For example, a user may be engaged in typing out a text message to the user's spouse about a dinner party, such as the dinner party discussed above in respect of FIGS. 3A-3H. While the user is typing, the system can monitor user input and determine that it may be helpful to render a modal window or notification to provide the user with additional information. For example, if the user types to the user's spouse “would you prefer chocolate or vanilla for the cake?” the system can present a modal dialog in an unobtrusive manner that reads “Restaurant ABC is rated higher for chocolate desserts” or “Chocolate may pair more naturally with the dinner menu” or similar. In other cases, the user may type or dictate to the user's spouse, “can you pick up the cake today?” to which in response the system can generate a modal window reading “the cake will be ready at 6 pm, and requires a payment of $75.” The system can dismiss the dialog upon determining that the conversation between spouses no longer requires the context of timing or price. For example, if the user's spouse replies, “sure, 6 pm right?” then the system may determine that context related to timing is not necessary; the dialog can be automatically dismissed.

These foregoing embodiments depicted in FIGS. 3A-3H and the various alternatives thereof and variations thereto are presented, generally, for purposes of explanation, and to facilitate an understanding of various configurations and constructions of a system, such as described herein. However, it will be apparent to one skilled in the art that some of the specific details presented herein may not be required in order to practice a particular described embodiment, or an equivalent thereof.

Thus, it is understood that the foregoing and following descriptions of specific embodiments are presented for the limited purposes of illustration and description. These descriptions are not targeted to be exhaustive or to limit the disclosure to the precise forms recited herein. To the contrary, it will be apparent to one of ordinary skill in the art that many modifications and variations are possible in view of the above teachings.

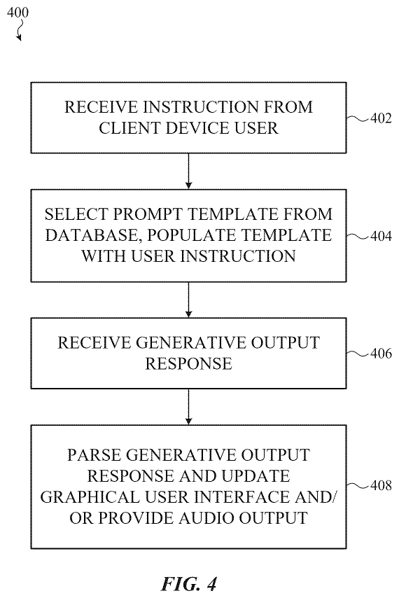

FIG. 4 is a flow chart depicting example operations of a method of defining a graphical user interface from textual output of a large language model. The method 400 includes operation 402 at which an instruction from a user is received via an input modality (e.g., voice, touch, and so on). At operation 404, a prompt template may be selected and populated. Next, at operation 406, a generative output can be received and finally at operation 408 the generative output can be parsed in order to generate or update a user interface as described herein. The method 400 can be performed by a client device, a host server, or a dedicated prompt management service such as described herein.

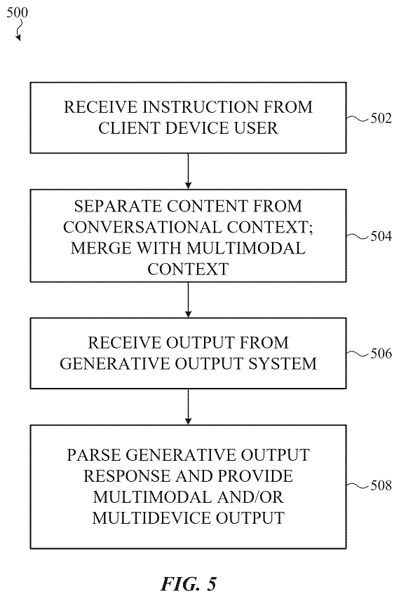

FIG. 5 is a flow chart depicting example operations of a method as described herein. The method 500 includes operation 502 at which an instruction from a user of a client device is received via one or more modalities. Next, at operation 504, content and conversational context are separated from one another and/or extracted from the user input received at operation 502. The context can be merged with any other appropriate multimodal input context. Next, at operation 506, output from a generative output system can be received and finally at operation 508, the generative output can be parsed in order to provide output via one or more output modalities.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, and developed by leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

It may be further appreciated that a request-response RESTful system implemented in whole or in part over cloud infrastructure is merely one example architecture of a system as described herein. More broadly, a system as described herein can include a frontend and a backend configured to communicably couple and to cooperate in order to execute one or more operations or functions as described herein. In particular, a frontend may be an instance of software executing by cooperation of a processor and memory of a client device. Similarly, a backend may be an instance of software and/or a collection of instantiated software services (e.g., microservices) each executing by cooperation of a processor resource and memory resources allocated to each respective software service or software instance. Backend software instances can be configured to expose one or more endpoints that frontend software instances can be configured to leverage to exchange structured data with the backend instances. The backend instances can be instantiated over first-party or third-party infrastructure which can include one or more physical processors and physical memory devices. The physical resources can cooperate to abstract one or more virtual processing and/or memory resources that in turn can be used to instantiate the backend instances.

The backend and the frontend software instances can communicate over any suitable communication protocol or set of protocols to exchange structured data. The frontend can, in some cases, include a graphical user interface rendered on a display of a client device, such as a laptop computer, desktop computer, or personal phone. In some cases, the frontend may be a browser application and the graphical user interface may be rendered by a browser engine thereof in response to receiving HTML served from the backend instance or a microservice thereof.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

As described herein, the term “memory” refers to any software and/or hardware-implemented data storage device or circuit physically and/or structurally configured to store data in a non-transitory or otherwise nonvolatile, durable manner. This term is meant to encompass memory devices, memory device arrays (e.g., redundant arrays and/or distributed storage systems), electronic memory, magnetic memory, optical memory, and so on.

What is claimed is:

1. A multimodal interface system comprising:
a display comprising a touch-sensitive input surface;
a microphone;
a speaker;
a processor; and
a memory operably coupled to the processor and storing an executable asset that when accessed by the processor configures the processor to instantiate an instance of a prompt management service, the prompt management service configured to:
receive each of a voice input from the microphone and a touch input from the touch screen within a time window;
define an input context based at least in part on the voice input and based at least in part on the touch input;
extract an instruction from at least one of the voice input or the touch input;
generate a prompt based on the input context and the instruction;
provide the prompt as input to a generative output engine and receive a response from the generative output engine, the response comprising executable code;
cause the processor to execute the executable code to receive a result;
parse the output instruction to obtain a visual output and a voice output;
cause the display to render a graphical user interface element based on at least one of the result or the visual output; and
cause the speaker to provide the voice output synchronized with rendering of the graphical user interface element.

2. The multimodal interface system of claim 1, wherein the voice output comprises a spoken phrase synchronized with rendering of the graphical user interface element.

3. The multimodal interface system of claim 2, wherein rendering of the graphical user interface element comprises emphasizing the graphical user interface element synchronized with timing of a demonstrative pronoun of the voice output.

4. The multimodal interface system of claim 1, wherein rendering of the graphical user interface element is initiated based on a timestamp associated with a lexical element of the voice output.

5. The multimodal interface system of claim 1, wherein the voice output comprises a spoken phrase and the graphical user interface element comprises a button rendered with text, the spoken phrase and the text each referencing a same potential action.

6. The multimodal interface system of claim 1, wherein the voice input comprises a phrase comprising a demonstrative pronoun and the touch input comprises a location on the touch-sensitive input surface corresponding to a graphical object rendered on the display.

7. The multimodal interface system of claim 6, wherein the input context associates the demonstrative pronoun to the graphical object.

8. The multimodal interface system of claim 1, wherein the executable code comprises a code snippet configured to access an application programming interface of an application installed on the computing device.

9. The multimodal interface system of claim 8, wherein the application is at least one of a calendar application, an email application, or a messaging application.

10. The multimodal interface system of claim 1, wherein the executable code comprises a query of a third-party service.

11. The multimodal interface system of claim 1, wherein the prompt management service is further configured to determine whether execution of the executable code results in a compilation error.

12. The multimodal interface system of claim 11, wherein the prompt management service is configured to generate a modified prompt based on the compilation error and provide the modified prompt to the generative output engine.

13. A multimodal interface system comprising:
a display comprising a touch-sensitive input surface;
a microphone;
a speaker;
a processor; and
a memory operably coupled to the processor and storing an executable asset that when accessed by the processor configures the processor to instantiate an instance of a prompt management service, the prompt management service configured to:
receive a first voice input and a first touch input within a first time window;
define a first input context based on the first voice input and the first touch input;
receive a second voice input following the first time window;
determine that the second voice input corresponds to a second input context distinct from the first input context;
generate a first prompt based on the first input context and a second prompt based on the second input context; and
provide the first prompt and the second prompt as inputs to a generative output engine and to receive in response, for each prompt, a respective structured response comprising at least one of a textual output, a graphical user interface definition, or executable code.

14. The multimodal interface system of claim 13, wherein the structured response comprises executable code that when executed by the processor performs a request to a third-party application via an application programming interface.

15. The multimodal interface system of claim 13, wherein the structured response comprises a graphical user interface element rendered on the display.

16. The multimodal interface system of claim 13, wherein:
the display is a first display; and
the structured response comprises a graphical user interface element rendered on a second display.

17. The multimodal interface system of claim 13, wherein the prompt management service is configured to determine whether the executable code produces a compilation error.

18. The multimodal interface system of claim 17, wherein the prompt management service is configured to generate a modified prompt based on the compilation error and provide the modified prompt to the generative output engine.

19. The multimodal interface system of claim 13, wherein the structured response comprises a textual response and one or more HTML elements.

20. A method of operating a multimodal interface system, the method comprising:
receiving, by a microphone of the multimodal interface system, a voice input comprising a demonstrative pronoun;
receiving within a time window of receiving the voice input, by a touch-sensitive input surface of a display of the multimodal interface system, a touch input to a graphical object rendered on the display;
defining, by a processor of the multimodal interface system, an input context based on the voice input and the touch input;
generating, by the processor, a prompt based on the input context;
providing the prompt as input to a generative output engine and receiving a response from the generative output engine, the response comprising a textual response and one or more graphical user interface elements;
causing the processor to parse the response to obtain a visual output and a voice output; rendering a graphical user interface element associated with the graphical object on the display based on the visual output; and
providing the voice output using a speaker of the multimodal interface system, the voice output being synchronized in time with rendering of the graphical user interface element.
